(19) United States
(12) Patent Application Publication
(10) Pub. No.: US 2008/0014418 A1
(43) Pub. Date: Jan. 17, 2008

(54) Corrugated laminated assembly having high quality graphic film surface

(75) Inventor: Jesse D. Crum, Fort Scott, KS (US)

Correspondence Address: Michael C. Maier, Esq.;Ward Kraft, Inc., P.O. Box 938, Fort Scott, KS, 66701, US

(73) Assignee: Ward/Kraft

(21) Appl. No.: 11/487,820

(22) Filed: Jul. 17, 2006

(51) Int. Cl. B32B 3/00

(52) U.S. Cl. 428/204

(57) ABSTRACT

The present invention relates to a corrugated packaging intermediate that may be used in the creation of consumer package products, including corrugated package application. The assembly of the present invention includes an intermediate layer, that has a series of regularly occurring undulations, and to one side or face of the intermediate layer is applied a backing material and to the other side or face, opposite the backing layer is a transparent or substantially transparent or translucent film that has been printed with an image in a reverse format. The image is further highlighted by providing an opaque backing coating over at least a portion of the image.

### CROSS-REFERENCES TO RELATED APPLICATIONS

None.

### FIELD OF THE INVENTION

The present invention relates to a laminated and preferably, a corrugated assembly that may be produced with a high quality image rendered on an exterior surface of the laminate. The construction may be used in packaging applications, such as point of sale retail applications where packaging is used as the “face to the consumer.” The assembly of the present invention includes a fluted core that has one base sheet that may be printed with relevant indicia and an exterior film sheet that is preferably pre-printed with high resolution graphics and or textual information prior to being formed into a laminated configuration that can be utilized in corrugated packaging type situations. The intermediate assembly is used in the formation of cartons, packages and the like that are intended to be used in various consumer applications such as parcel delivery, including the shipping and delivery of consumer packaged goods.

The intermediate assembly and final product construction of the present invention is formed from three sheets or webs of material, two of which may be printed with indicia that may include matching characteristics and the third sheet which is fluted to form a core on to which the two printed sheets are attached. In constructing a product in this configuration, the package or carton forms an enhanced communication vehicle that can be further used in explaining a product offering and thereby taking further advantage of a marketing campaign or theme.

### BACKGROUND OF THE INVENTION

There are currently a plethora of business communication constructions, marketing and advertising pieces and other items that are available in the market today for communicating products and services with an intended audience. Yet with this inordinately large selection of offerings and permutations, there remains a continuing need to develop new products due to changes in technology, societal trends, diversification of marketing, packaging and advertising campaigns and new information handling needs of businesses and consumers alike.

However, while printed products, such as pieces and other assemblies that are intended to be used in business communications, can be delivered in a wide variety of formats, constructions and configurations, the manufacturing of such diversified products may simply be unattainable by most producers of such products, particularly smaller sized manufacturers, or may simply be too expensive to justify expenditures for equipment that may be able to create such products.

Typically, one of the most significant limiting factors for a manufacturer in being able to produce a particular construction or expand product capabilities is the available equipment the manufacturer has on hand or which may be available on the market to generate such printed pieces. Such forms handling machinery and other printing apparatus even if available for acquisition can be quite expensive and in addition the equipment may require some customization before the equipment can be integrated into a particular manufacturing processes. Thus, egress into new product categories may simply not be possible due to cost constraints.

Equipment may be further limited by the type of stocks, sheets, webs or substrates that can be effectively handled or processed by such presses thereby further limiting the potential output of the types of products from manufacturers. For example, board or tag stocks are exemplary materials that due to the thickness of the substrate may not be able to be handled by most types of equipment and thus cannot printed upon by such conventional printing technologies as flexographic.

Flexography is one exemplary conventional technology that is commonly used today for the printing of decorative items, packaging films and the like because of the ability of the technology to print substrates in multiple colors. However, flexography is one exemplary technology that suffers from the foregoing drawbacks, of being able to handle thicker substrates and add significant variability to the materials being produced.

Flexographic technology is commonly used today in the rendering of film packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch. In addition, flexographic printing presses are also limited by the thickness of the substrates that can be effectively handled and processed by the equipment.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While use of such conventional technology such as flexography is desirable in the printing of films and other materials due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With increasing sophistication of consumers, as well as technology and expectations from each, such effects may be undesirable to potential end users.

The market for printed communication material is also changing and becoming more sophisticated. Such conventional business forms manufacturers have normally produced product runs that range in the hundreds of thousands to millions or even tens of millions of pieces for a single order. These single orders may be produced for example in connection with a multiple part medical form product, insurance form or the like. As such, the equipment that is used to produce product at these levels or quantities is then set up to handle only large manufacturing runs. The apparatus used in this type of fulfillment will normally only operate efficiently in this higher range of production quantities and often cannot be reconfigured as the apparatus has been constructed in such a specific manner so as to be able to optimize production efficiencies of these larger runs. Thus, even if a manufacturer wished to pursue smaller runs, particular niche markets opportunities, specialty configurations or orders sizes, the manufacturer is faced with the dilemma of making new capital expenditures to purchase equipment that specializes in this type of application. This along with the possibility of having to retrain existing personnel or hire and train new employees to generate this type of production activity places additional constraints on the decision making process.

Traditional manufacturers of business communications, such as business forms, may also be limited in the type of jobs that a manufacturer will accept and have typically not pursued more lucrative areas such as consumer goods packaging due to the uniqueness of the equipment that may be used in producing such products. These additional factors may include the size of the job, or more particularly the order quantity or value of the order. That is, due to cost factors, a customer will not place an order with a manufacturer for a small to medium quantity of specialty pieces as the set up or make ready of the job makes the order cost prohibitive, even assuming that the manufacturer would accept the order if a particular price could be obtained to justify production.

A still further drawback of trying to migrate to smaller customer applications relates to quality of the pieces that need to be generated. With the focus of the market slowly shifting to smaller runs, the end user is now demanding a greater image quality than that typically associated with conventionally printed products. It is believed that one of the reasons for such far reaching changes is that budgets for marketing and business communications have been cut back in recent years and as such, end users want more from each piece that is produced rather than relying on the quantity of pieces to generate the desired result. In addition, marketers want to make a greater impact at every turn in the retail chain to try and maximize the chances for purchases of a particular product being offered. Providing opportunities to extend or enhance marketing trends has been commonly welcomed by such firms and such priorities or demands often drive manufacturers to seek out other opportunities.

With the change in focus to quality as opposed to quantity there are a number of products that to date are still out of reach of conventional manufacturers in that certain materials are simply to thick or unwieldy to be able to be handled by printing equipment and forms processing apparatus.

In addition, with the rise of consumer oriented services, such as increases in purchasing occurring over a global communications network; many products that are intended for retail or consumer use only reach the consumer in the original, relatively plain shipping package or container. These relatively bland packages which are stored in warehouses are placed on pallets on the floor and then the distribution company loads the package for delivery to the consumer. The customer then removes the goods from the package upon arrival at one's home. Thus, such conventional packaging does little in the way of marketing or encouraging point of sale type activity to entice a consumer to purchase one product over another or to acquire additional complimentary products, upgrades or other services that may be of interest to the consumer.

In this age of brand marketing, and positioning of products in the consumer focus, so much of the effort associated with advertising and marketing to the consumer through conventional media outlets (e.g. television, radio, magazines, etc.) is then lost, as the package does not necessarily complete the image or finish the delivery of the message that the manufacturer of the consumer good wishes to convey to prospective customers.

This situation of plain or bland packaging is further exacerbated in connection with large marketing or promotional initiatives such as may occur around particular holiday seasons, or with the release of long awaited software or hardware, publications or new product launches. Marketing and/or advertising agencies spend significant sums in order to communicate to the public the launch or release of a product or service. The effect of this large effort can be mitigated due to the relatively uneventful packaging in which the product is delivered to the ultimate consumer.

There have some attempts to modify packaging so as to make the packaging more appealing to consumers. Some cartons may have printed sheets, sheets that provide a picture of the product, that are applied directly to the exterior of the carton. Such sheets do not typically cover the face of the side of the carton to which the sheet has been applied and may in fact detract from the quality of the product. In addition, it often appears as if the sheet was applied post packaging, which is in fact typically the situation. In such instances, the sheets can appear splayed or crooked on the surface, may bubble up due to incomplete lamination or sloppy application of the sheet to the carton, may rip or tear upon handling during shipping or simply be removed from the exterior of the carton thereby defeating the purpose of applying the sheet. As such, a more effective and aesthetically appealing point of sale vehicle is needed for such indirect customer driven applications.

Paperboard has been previously printed, such as with what may be found in connection with consumer food packages. However, it is well known that paperboard packaging simply does not work in connection with delivery or courier situations as the paperboard material simply does not provide enough protection or durability during shipping when compared with materials such as corrugated stock and the like.

Thus, what is needed is a corrugated packaging type construction that can be produced in a novel manner that enables the utilization of high resolution imaging equipment to create a more visually stimulating package. Such a construction would provide conventional manufacturers of business communication products with the ability to produce attractive and effective business communication laminates that may be used in preparing relatively thick stocks of material, such as corrugated packaging materials with high quality graphics thereby creating enhanced marketing platforms.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that there is no readily available method or process by which to create a high quality printed communication corrugated platform, substantially in situ, which can be used in conventional corrugated packaging applications. It has been found that by handling the components of a packaging laminate individually, the high quality graphics, matching and personalized indicia can be applied to the packaging carriers in order to provide a vehicle by which a marketing message can be carried completely to the end user customer.

It has been discovered that by applying an over coating to an image that has been printed on a transparent or substantially transparent layer, with a pigmented material, such as a white opaque material, an image may be created that has a significantly improved level of resolution and the integrity of the packaging assembly construction is enhanced by eliminating an interposed paper layer. By constructing the packaging assembly in accordance with the present invention, the ink dot geometry is substantially preserved which is believed to improve the resolution of the image that is printed on the substrate. That is, the image may permit some level of dot growth on the surface of the substrate such that the image may stretch slightly upon application without suffering from microscopic cracking which may occur in conventional printed, packaging assemblies. In addition, it is believed, that by retaining a somewhat circular dot configuration, that is by not completely compressing the dot as may occur through the application of a solid ply backing layer, the image may be permitted to expand to some degree thereby allowing the packaging intermediate assembly to function in a number of different use applications.

In one exemplary embodiment that may be practiced in connection with the present invention, a corrugated packaging assembly is described and includes a base material that has first and second faces. An intermediate material is provided and the intermediate material has a series of regularly occurring and repeating undulations with each undulation having a substantially equal height and width. The intermediate material is applied to the first face of the base material.

A substantially transparent material that has first and second faces and first and second edges and first and second sides is included in connection with the present invention. An image is applied to the second face of the substantially transparent material. The image is produced in a reverse format so as to be visible through the first face of the substantially transparent material.

A white pigmented layer is applied substantially entirely over the image. The pigmented layer is used to create an opaque backing for the image. A layer of adhesive is applied substantially entirely over the white pigmented layer to create a printed image layer. The printed image layer is applied over the intermediate layer opposite the base layer to create a printed corrugated package material.

In a still further exemplary embodiment that may be practiced in connection with the present invention, a packaging intermediate is described and includes a backing layer that has first and second faces and at least first and second transversely extending edges. An intermediate layer that has first and second sides and at least first and second transversely extending edges. The intermediate layer has a regularly occurring series of undulations and the second face of the backing layer is applied so as to be substantially juxtaposed over the second side of the intermediate layer.

A facing layer that has first and second faces and at least first and second transversely extending edges. The facing layer is at least translucent and has an image applied to the second face in a reverse format. The facing layer, second face further includes a substantially opaque coating that is applied over at least a portion of the image. The facing layer, second face with the image and the coating is applied so as to be substantially juxtaposed over the intermediate layer first side, opposite the backing layer.

In a yet still further exemplary embodiment that may be practiced in connection with the present invention, a consumer good package is provided and includes a consumer good.

A packaging intermediate is provided in connection with the presently described embodiment; the packaging intermediate is provided and includes a backing layer that has first and second faces and at least first and second transversely extending edges. An intermediate layer that has first and second sides and at least first and second transversely extending edges. The intermediate layer has a regularly occurring series of undulations and the second face of the backing layer is applied so as to be substantially juxtaposed over the second side of the intermediate layer.

A facing layer that has first and second faces and at least first and second transversely extending edges. The facing layer is at least translucent and has an image applied to the second face in a reverse format. The facing layer, second face further includes a substantially opaque coating that is applied over at least a portion of the image. The facing layer, second face with the image and the coating is applied so as to be substantially juxtaposed over the intermediate layer first side, opposite the backing layer.

The packaging intermediate is formed around the consumer good in order to create a consumer goods package with the facing layer exposed and the backing layer adjacent the consumer good.

The backing layer may be printed with information that relates to the product, such as instructional or use details. In addition, the indicia that is printed on the backing layer may have matching indicia to that printed on the facing or film layer.

The opaque coating or white pigmented layer is provided preferably with particulate material or pigments that are dispersed throughout the coating layer. The particulate or pigmentation may be applied relatively homogenously throughout the coating layer or alternatively, may be disposed in varying gradients from high to low densities, so that highlighting or other image features may take on different levels of clarity or resolution. In addition, the pigmented layer may be applied in differing thicknesses across the image so as to create various degrees of shading so that changing effects can be created in the image when viewed through the film or facing layer.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross section of the intermediate assembly prepared in accordance with the present invention;

FIG. 2 illustrates a cut away of the facing layer of the blank of the packaging intermediate assembly prepared in accordance with the present invention;

FIG. 3 shows a consumer goods package including the packaging construction prepared in connection with the present invention;

FIG. 4 provides a cut away of the backing layer of the blank of the packaging intermediate assembly prepared in accordance with the present invention; and

FIG. 5 depicts the exterior face of a consumer goods package that is prepared in connection with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The instant specification sets forth a unique concept by which conventional corrugated type packaging material can be prepared using commercial quality imaging and business forms type processing equipment in a manner so as to enhance consumer goods packaging in order to provide a more attractive marketing package for the customer of a particular product or service.

The printing or imaging that is applied to the sheets of material that form the inner and outer surface of the packaging carton when formed will preferably have complimentary imaging relating to the consumer good that is contained within the package. The imaging or printing can be used to convey information about other related or complimentary products, upgrades or enhancements for the productions, marketing, advertising or promotional information relating to the products, or other members of the product families as well as product announcements, information and the like. In addition, the printing or imaging such as that which will be provided on the film or facing layer can be used to create gift packages such as by printing colorful patterns or designs, similar to those found on wrapping paper as well as names and gift giving occasions such as birthdays and holidays. Thus, the invention described in the instant specification can be used to create a personalized package from what was at one time considered relatively bland conventionally packaging material.

There are a number of terms used throughout the instant specification that are discussed below in cursory terms. The definitions provided are not intended to limit the scope of the invention and the information is provided for illustrative purposes.

As used herein the term “business communication” is used to refer to a printed or imaged piece, document or substrate that when used with the a laminate as described in the present invention will convey a particular message, image or provide information about a particular product or service that is available from the provider of such pieces or documents. Business communications, documents or pieces can include advertising, sales and marketing collateral and such other items used to convey information, and in connection with the present invention.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering, laminating and the like. Typically, a product such as with the present invention is provided in an intermediate condition so that a user or downstream manufacturing point can add or manipulate the intermediate to create the final or desired end product, such as creating a finished carton or package by folding and shaping. Thus, in accordance with the present invention, the intermediate segment for example, could be subject to die cutting or additional printing, such as through ink jetting, over laminating, coating or embossment, and then applied to a blank for further processing, such as to create a package, carton or the like.

The term “personalized information” refers to information that is printed or imaged onto a substrate or document which is generally variable or unique and which may change from laminate to laminate so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from laminate to laminate and may include a general description or body of information about particular products, services, places, etc. that may be of interest to the intended recipient and represents a standard message that the manufacturing or supplier wishes to convey to an end user or customer of the offering.

The glossy film stock that is used in accordance with the present invention is a clear polyethylene film, such as PET, which has a thickness of less than 30 mils and preferably less than about 20 mils and still more preferably less than about 10 mils. The film layer can be laminated to the fluted layer either through the use of adhesive or alternatively by a heated roller that may shrink and seal the film directly over the surface of the intermediate layer or activate the adhesive to adhere the adhesive to the segment. The film may preferably be pre-printed with indicia using a high quality resolution imaging device, which is capable of rendering an image having a resolution of greater than about 150 lines per inch. The printing may be complimentary to the printing on the backing sheet, for example a pictorial overlay that accentuates the textual image, so as to form a complete message.

In addition, the film stock may be partially transparent or clear and partially opaque or substantially translucent. The film may be applied in a continuous fashion over the surface of the web or alternatively, the film may be cut into individual pieces or segments with each segment being sized and configured to be about the size of the intermediate laminate, a combination of the fluted layer and backing layer.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide images on a substrate that has a resolution quality of about 150 or more lines per inch and preferably more than 300 lines per inch, which is approximately equal to about 2500 to 3500 dots per inch (“DPI”) in order to create a high quality image that is intended to be aesthetically appealing to the consumer. Other imaging equipment may of course be used depending on the sheet or web size that the equipment can efficiently handle. For example, the backing layer can be printed using conventional flexographic technology in which static or fixed printing is applied and then the substrate can be processed through an ink jet printer to add personalized information.

The system can be used to produce highly personalized textual information in addition to generating high quality, high resolution graphical images. Such textual information may include details relating to the graphics to be generated.

It has been discovered, that when the image is applied to the plastic film, the ink dots that are generated by the printing device will only flatten partially on the surface of the film and that by then over coating the printing with an opaque, pigmented material, the integrity of the dots geometry is substantially retained as the coating flows around the dots, as opposed to further flattening the dots and thus helps to retain the integrity of the dot shape. This surprisingly is different from prior art solutions, wherein a paper layer of material is applied over the dots, which further compresses the ink as well as causes some of the ink to be absorbed into the paper layer thus decreasing the level of ink dot integrity and resolution. Any absorption of the ink into the paper backing layer will likely diminish the image quality. In addition, as such images dry or cure, any bending of the packaging may cause some level of microscopic cracking of the image further contributing to the reduction in the quality of the packaging stock or material.

The ink pattern that creates the image or images is then held on the surface of the film, in a reverse format pattern, by the over coating layer. This is opposed to other substrates or coatings, where the coating and/or substrate may partially or fully absorb the ink.

It is believed, that through the practice of the present invention, the amount of the external stresses on the ink dot configuration or the circular geometry of the ink pattern can be incrementally reduced thereby enabling the ink or particular ink dot pattern to coalesce better in order to retain the image design and quality of the printed image design and permit some level of image stretch due to potential dot growth.

It is believed that when printing the ink dots on the substrate, the ink dots will flatten partially upon impact on the substrate (substantially transparent or transparent film), that is the dots will not be absorbed by the material onto which the ink is printed. The ink will remain on the surface of the substrate until cured, or until pressure is applied and the ink is otherwise absorbed. However, it is suspected that by providing an opaque coating that will surround the ink dots as opposed to a backing material that will create incremental pressure over the surface of the dots such as may occur with a sheet as is commonly accomplished in the prior art, the ink dots will remain in a partially flattened condition and be partially suspended within the opaque coating so that the surface geometry does not change and the individual ink dots are protected from further flattening.

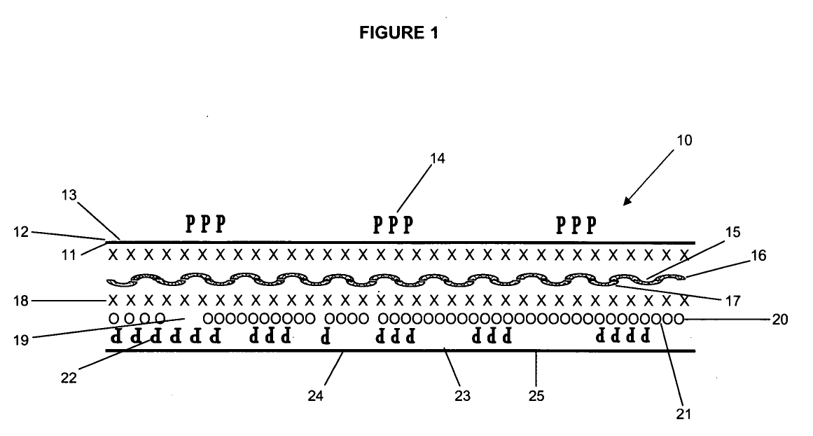

Reference is now directed to FIG. 1 of the presently described embodiment, in which the packaging intermediate assembly is generally designated by reference to numeral 10. The intermediate assembly 10 includes a backing layer 12, which has first and second faces 11 and 13. It should be understood that the references to the faces is done for convenience for discussion purposes and that the first and second faces may be reversed or switched. The second face 13 is provided with printing 14 (designated by characters “PPP”) in predetermined areas. The printing may be personalized or alternatively, the printing may be fixed/static or personalized. To the first face 11, a layer of adhesive is applied so as to be able to adhere the backing layer 12 to the intermediate layer 16.

The intermediate layer 16 is provided with first and second faces 15 and 17 and is provided with a series of regularly occurring undulations, which consist of a series of peaks and valleys that have substantially equivalent lengths and widths. The first face 15 of the intermediate layer 16 is applied to the first face of the backing layer 12 as described above. The adhesive is preferably a permanent pressure sensitive adhesive which will prevent the layers from delaminating during subsequent forming of the package or use and handling of the package.

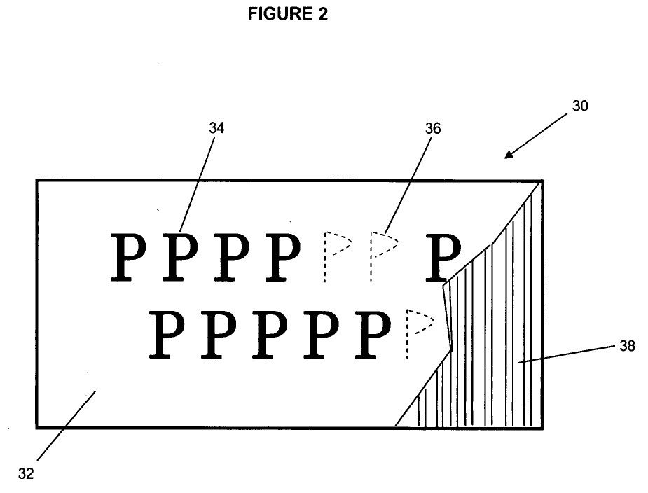

To the second face 17 of the intermediate layer 16 is another layer of adhesive 18 which again will preferably a permanent adhesive. Disposed over the adhesive layer 18 is a coating layer 20, which will preferably be a white pigmented layer, to create a relatively opaque backing for the image layer 22. An exemplary material suitable for this coating layer includes Phase 36 available from Arcar Graphics of West Chicago, Ill. The pigmented layer 20 is shown ranging from a lower density area 19 to a higher density area 21 (where the amount of pigment or particulate matter occurs at a greater level than the lower density level). By providing the pigmented layer 20 in a gradient that can shift in density from one portion of the image to another (a first area to a second area), the image 22 can appear to be “shaded” or “fogged” such that a portion of the image 22 in which a higher density of pigmentation appears behind will have a sharper or more distinct appearance whereas an area where a lower density is disposed, the image will appear more washed out than the area backed by the higher density pigmented portion (see FIG. 2). That is, the opacity of the backing coating changes over the gradient such that more light will pass through areas in which a lesser amount of pigmentation is present such that the image will appear weaker in the areas backed by the lesser pigmentation areas. Voids or gaps may also be provided in the coating layer to provide further gradients in the image. In addition, patterns can be created in the coating layer to emphasize certain areas of the image.

The image 22 will be printed in a reverse format (shown as a series of upside down characters “PPP”) so that the image will be visible through the face of the film or facing layer 24. The film layer 24 again has first 23 and second faces 25, with the first face receiving the image and the second face 25 appearing on the exterior of the package and which will serve as the “face” to the customer such as in a retail environment.

FIG. 2 shows a cut away portion of the packaging laminate intermediate of the presently described embodiments shows the exterior surface 32 of a sheet prepared in accordance with the present invention and generally designated by reference to numeral 30. The face 32 is preferably a clear film layer, such as PET, polyolefin or other polyester based material. The printing 34 and 36 is shown at two different levels of resolution with 34 appearing “sharper” or clearer than the second portion of the image 36. That is, the shaper image portion will have a higher density of pigmentation or coating thickness than the second portion behind the less sharp image. The density between or coating thickness can vary by as much as 99.9% between the two areas, with 80% being preferred.

In FIG. 2, the upper portion of the film sheet 32 has been cut away to reveal the intermediate fluted layer 38 which shows a series of regularly occurring ridges and valleys which are substantially equal in length and width.

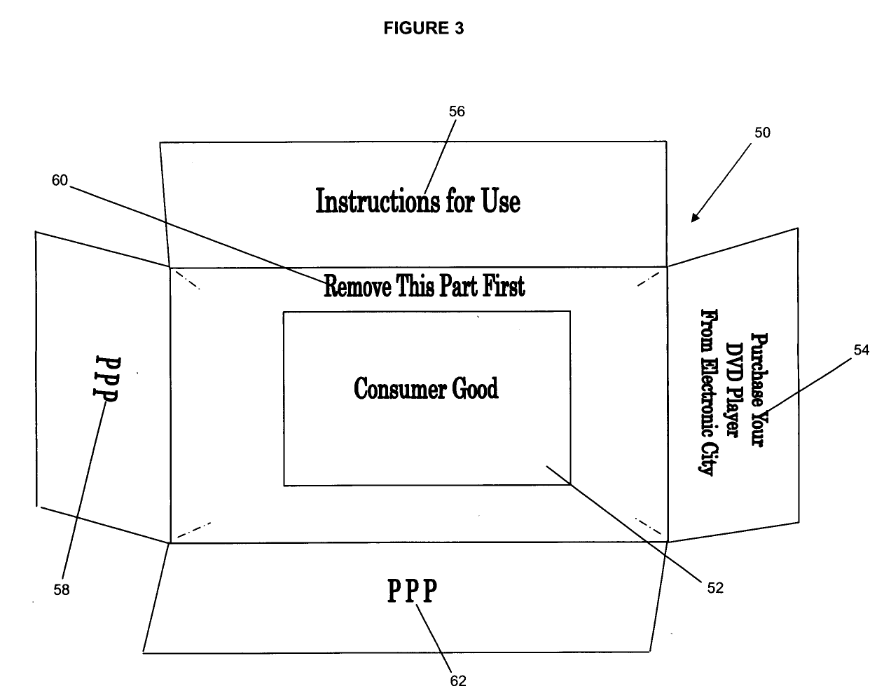

FIG. 3 provides a consumer goods package designated generally by reference to numeral 50 and includes a consumer good 52. The package 50 is formed from a blank of the laminate material shown in the cross section provided in FIG. 1. The package depicted in FIG. 3 shows the imaging provided on the interior of the package 50 which is created by printing on the backing layer. Imaging is represented by reference numerals 52, 54, 56, 58, 60 and 62. The imaging has been used in the present example to provide use or other informational instructions 56 and 60, as well as to provide marketing communications 54. The printing on the backing layer is preferably complimentary to the consumer good contained in the package and may also match the printing that is provided on the face of the package, that is the reverse printed image visible through the clear film layer laminated to the fluted intermediate.

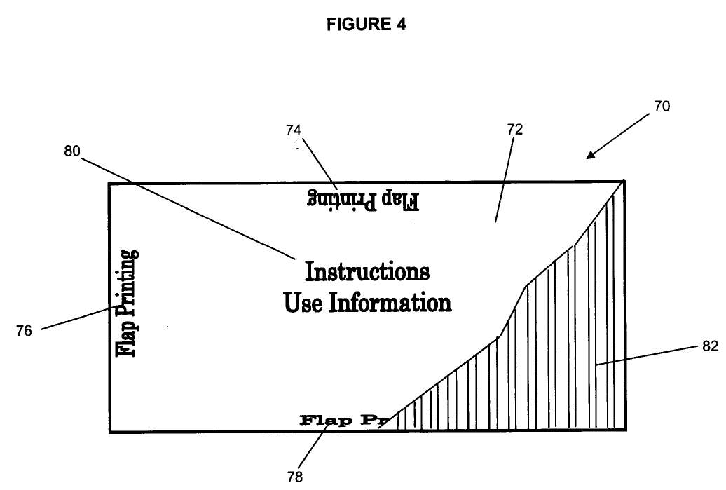

FIG. 4 provides a sheeted format, similar to FIG. 2, illustrating the backing layer of the intermediate generally designated by reference numeral 70. The backing layer face 72 is shown with a number of printed areas 74, 76, 78 and 80. Printed areas 74, 76 and 78 are printed areas that may be created for printing on the portions of the laminate that will become the flaps of a carton for example. Printed area 80 is used to provide instruction and which form, for example, the interior panels of the carton or package. In this way, none of the backing layer of the package intermediate is wasted and various communications can be provided to the end user or customer.

FIG. 4 also shows a cut away portion in which the fluted intermediate 82 is shown. The face of the intermediate 82 is opposite the face shown in FIG. 2 and again shows a regularly occurring series of undulations having peaks and valleys.

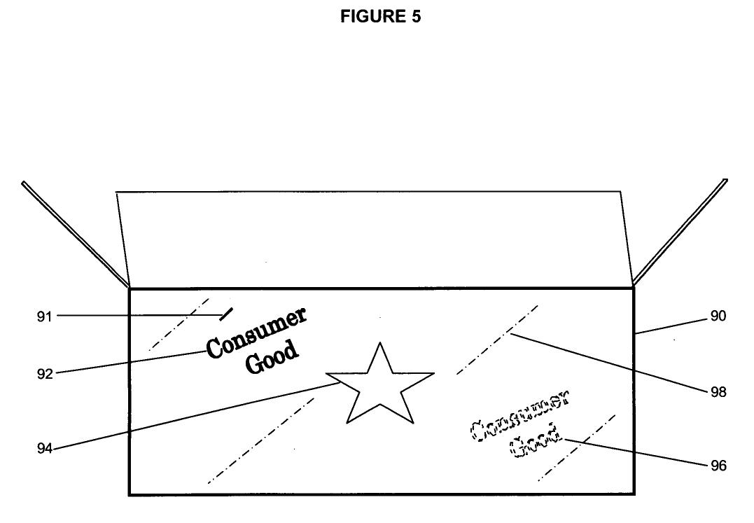

Turning now to FIG. 5 of the presently described embodiment, an exterior face 91 of a consumer goods package 90 is provided. The exterior face 91 shows a first sharp printing 92 which includes textual information and 94 which provides a graphical depiction. Printed area 96 is shown in a “faded” condition as the density or thickness of the coating behind the printed area is less than that behind areas 92 and 94. The glossy appearance of the film is illustrated by numeral 98.

It will thus be seen according to the present invention a highly advantageous corrugated intermediate assembly and package formed there from has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A corrugated packaging assembly, comprising;
a base material having first and second faces;
an intermediate material, said intermediate material having a series of regularly occurring and repeating undulations with each undulation having a substantially equal height and width, said intermediate material applied to said first face of said base material;
a substantially transparent material having first and second faces and first and second edges and first and second sides;
an image applied to said second face of said substantially transparent material, said image is produced in a reverse format so as to be visible through the first face of the substantially transparent material;
a white pigmented layer applied substantially entirely over said image, said pigmented layer creating an opaque backing for said image;
a layer of adhesive applied substantially entirely over said white pigmented layer to create a printed image layer; and
wherein said printed image layer is applied over said intermediate layer opposite said base layer to create a printed corrugated package material.

2. A corrugated packaging as recited in claim 1, wherein said adhesive layer is substantially clear.

3. A corrugated packaging as recited in claim 1, wherein said white pigmented layer and said adhesive layer are applied substantially simultaneously.

4. A corrugated packaging as recited in claim 1, wherein said white pigmented layer is provided over said image ranging from a high density of particulate material to a low density of particulate material.

5. A corrugated packaging as recited in claim 1, wherein said adhesive layer is provided in a pattern substantially equivalent to said image.

6. A corrugated packaging as recited in claim 1, wherein said image is produced at a resolution of greater than about 150 lines per inch.

7. A packaging intermediate, comprising;
a backing layer having first and second faces and at least first and second transversely extending edges;
an intermediate layer having first and second sides and at least first and second transversely extending edges, said intermediate layer having a regularly occurring series of undulations and said second face of said backing layer is applied so as to be substantially juxtaposed over said second side of said intermediate layer;
a facing layer having first and second faces and at least first and second transversely extending edges, said facing layer is at least translucent and having an image applied to said second face in a reverse format, said facing layer, second face further including a substantially opaque coating applied over at least a portion of said image; and
said facing layer second face with said image and said coating is applied so as to be substantially juxtaposed over said intermediate layer first side, opposite said backing layer.

8. A packaging intermediate as recited in claim 7, wherein said first face of said backing layer is provided with printing.

9. A packaging intermediate as recited in claim 7, wherein said facing layer is adhered to said intermediate layer with a permanent, pressure sensitive adhesive.

10. A packaging intermediate as recited in claim 7, wherein said second face of said backing layer is provided with an adhesive.

11. A packaging intermediate as recited in claim 7, wherein said image is produced in a reverse format on said facing layer.

12. A packaging intermediate as recited in claim 7, wherein said substantially opaque coating has a substantially uniform dispersal of particulate material.

13. A packaging intermediate as recited in claim 7, wherein said facing layer has a first thickness and said backing layer has a second thickness distinct from said first thickness.

14. A packaging intermediate as recited in claim 7, wherein said facing layer is substantially transparent.

15. A consumer good package, comprising;
A consumer good;
A packaging intermediate, said packaging intermediate including
a backing layer having first and second faces and at least first and second transversely extending edges;
an intermediate layer having first and second sides and at least first and second transversely extending edges, said intermediate layer having a regularly occurring series of undulations and said second face of said backing layer is applied so as to be substantially juxtaposed over said second side of said intermediate layer;
a facing layer having first and second faces and at least first and second transversely extending edges, said facing layer is at least translucent and having an image applied to said second face in a reverse format, said facing layer, second face further including a substantially opaque coating applied over at least a portion of said image;
said facing layer second face with said image and said coating is applied so as to be substantially juxtaposed over said intermediate layer first side, opposite said backing layer; and
wherein said packaging intermediate is formed around said consumer good to create a consumer goods package with said facing layer exposed and said backing layer adjacent said consumer good.

16. A consumer goods package as recited in claim 15, wherein said image on said facing layer is representative of said consumer good in said package.

17. A consumer goods package as recited in claim 15, wherein said backing layer first face is printed with instructions relating to use of said consumer good.

18. A consumer goods package as recited in claim 15, wherein said image on said facing layer is printed at a resolution of greater than about 150 lines per inch.

19. A consumer goods package as recited in claim 15, wherein said opaque coating is applied so as to substantially cover said image.

20. A consumer goods package as recited in claim 15, wherein said image is produced in a reverse format.
